(19) United States
(12) Patent Application Publication
(10) Pub. No.: US 2024/0351250 A1
(43) Pub. Date: Oct. 24, 2024

(54) Apparatus for transporting plastics preforms with elimination of disruptions

(71) Applicant: KRONES AG, Neutraubling (DE)

(72) Inventor: Juergen BEUTL, Sinzing (DE)

(21) Appl. No.: 18/639,617

(22) Filed: Apr. 18, 2024

(30) Foreign Application Priority Data
Apr. 18, 2023 (DE) 10 2023 109 658.3

(51) Int. Cl. B29C 31/00

(52) U.S. Cl. CPC B29C 31/008

(57) ABSTRACT

An apparatus for transporting plastics preforms, having a first transport element that extends along a transport path of the plastics preforms and having a second transport element parallel to the first transport element. The first transport element and the second transport element are spaced apart from one another such that a gap is formed between the first transport element and the second transport element such that a base body of the plastics preforms can pass through this gap, but a support ring of the plastics preforms cannot pass through this gap. The apparatus has a hold-down device that is arranged above the transport elements and/or the mouths of the plastics preforms, wherein the hold-down device has a first hold-down element movable in two opposite directions in a longitudinal direction of the plastics preforms along with a drive device configured to cause these movements during a transport operation of the apparatus.

### BACKGROUND OF THE INVENTION

The present invention relates to an apparatus and a method for transporting plastics preforms. It is known from the prior art that plastics preforms are initially heated and subsequently formed into plastics containers using a forming device such as a stretch blow molding machine. For this purpose, it is necessary for the plastics preforms, for example, to be separated from a chute and transported in an orderly manner. For this purpose, so-called roller sorters are used, for example, which have two rotating rollers between which the plastics preforms are transported. However, transport rails that transport the plastics preforms are also known.

Typically, the plastics preforms are transported between two rails, wherein a support ring of the plastics preforms rests on these rails and the base bodies of the plastics preforms protrude through these rails. At high transport speeds in particular, the plastics preforms do not lie completely evenly on the rails, but can twist or swivel. This can cause disruptions in transportation.

For this purpose, it is known from the prior art to also guide the plastics preforms through a hold-down device, which is usually arranged above them. Disruptions sometimes occur in this region. However, no elimination of disruptions is known from the prior art, particularly in a drain or a drain assembly of a roller sorter. If the plastics preforms become wedged in this assembly region, they must be released by hand.

The present invention is therefore based on the object of making it possible, in particular, to eliminate disruptions in such transportation devices.

### SUMMARY OF THE INVENTION

An apparatus according to the invention for transporting plastics preforms has a first transport element and in particular a first transport rail, which extends along a transport path of the plastics preforms. Furthermore, the apparatus has a second transport element and, in particular, a second transport rail that extends parallel to the first transport element, wherein the first transport element and the second transport element are spaced apart from one another such that a gap is formed between the first transport element and the second transport element such that a base body of the plastics preforms can pass through this gap, but a support ring and/or a thread of the plastics preforms cannot pass through this gap.

Furthermore, the apparatus has a hold-down device, which is arranged above the transport elements and/or above the mouths of the plastics preforms.

According to the invention, the hold-down device has a first hold-down element movable in two opposite directions in a longitudinal direction of the plastics preforms, along with a drive device that is suitable and intended to cause these movements at least temporarily during the transport operation of the apparatus.

Particularly preferably, this first hold-down element also extends in the transport direction of the plastics preforms. Particularly preferably, this first hold-down element extends parallel to the aforementioned transport elements.

In a particularly preferred embodiment, the transport elements are also adjustable in a height direction and in particular in the longitudinal direction of the plastics preforms to be transported. However, particularly preferably, such an adjustment is carried out outside of the apparatus being in operation.

Preferably, the gap formed between the transport elements can be changed and/or a lateral distance between the transport elements can be changed.

In a further advantageous embodiment, the drive device is suitable and intended to generate periodic movements of the first hold-down element and/or to generate circular movements of the first hold-down element, wherein one plane of these circular movements is particularly preferably aligned vertically in this case. Particularly preferably, this plane of circular movement is aligned in the transport direction of the plastics preforms or parallel to it.

The drive device is preferably an electric motor and in particular a motor with a rotary output.

In a further advantageous embodiment, the drive device has an eccentric element and/or a connecting rod drive.

In a further advantageous embodiment, the drive device has a second hold-down element and the first hold-down element is movably arranged with respect to the second hold-down element. Preferably, the second hold-down element is (at least also) arranged to be movable in the perpendicular and/or vertical direction with respect to the first hold-down element.

In a further advantageous embodiment, the second hold-down element is arranged in a stationary position. In particular, the second hold-down element is stationary in relation to the transport elements.

In a preferred embodiment, the second hold-down element has at least one first contact surface, which is suitable and intended for contacting portions of the plastics preforms. Preferably, this contact surface extends at least in portions along the transport path of the plastics preforms.

In a preferred embodiment, the second hold-down element has a second contact surface, which is suitable and intended for contacting portions of the plastics preforms. Preferably, this second contact surface extends at least in portions along the transport path of the plastics preforms.

In a preferred embodiment, the first and second contact surfaces of the second hold-down element are spaced apart.

Preferably, the two contact surfaces of the second hold-down element run at an angle to a transport plane of the plastics preforms and/or at an angle to a support plane, which is formed by the two transport elements.

Preferably, one contact surface of the first hold-down element is arranged between the at least two contact surfaces of the second hold-down element.

Therefore, preferably, in the case of the hold-down device, a further hold-down element is added, in particular in addition to the stationary (here, the second) hold-down element. This second hold-down element is preferably subject to a periodic movement and/or a circular movement, in particular in the movement direction of the plastics preforms.

Preferably, a touching surface and/or a touching region of the second hold-down element (i.e., a touching surface and/or a touching region that temporarily touches or is suitable for touching the plastics preforms) is temporarily or partially above and temporarily or partially below the touching surface of the first hold-down element.

Therefore, particularly preferably, the second hold-down element forms a touching surface, which is intended to touch the mouths and in particular the mouth edges of the plastics preforms. Particularly preferably, the first hold-down element also forms such a touching surface, which can touch the plastics preforms or their mouths. As explained, this touching surface of the second hold-down element is partially above and partially below the touching surface of the second hold-down element.

In this way, the height distance from the first hold-down element to the second hold-down element changes. If a plastic preform becomes wedged in the second hold-down element, this wedging can be released by pressing the plastics preform down through the first hold-down element.

In this way, an automatic elimination of disruptions is achieved in the assemblies and in particular in the apparatus described here.

In a further advantageous embodiment, the second hold-down element has a recess and the first hold-down element is arranged (in particular movably) in this recess. It is possible that the second hold-down element forms a gap within which the first hold-down element is arranged and/or movably arranged.

In a further advantageous embodiment, the first transport element and/or the second transport element is designed as a transport rail. Particularly preferably, both transport elements are designed as transport rails.

Particularly preferably, the above-mentioned gap, through which the base body of the plastics preforms can pass, widens downwards below the surfaces of the respective support elements. In this way, a more stable or disruption-free transport of the plastics preforms can be achieved. Particularly preferably, the aforementioned gap widens downwards and in particular widens in a conical or frustoconical shape.

In a further preferred embodiment, the first hold-down element performs a stroke that is greater than 0.1 cm, preferably greater than 0.2 cm, preferably greater than 0.3 cm, preferably greater than 0.4 cm, preferably greater than 0.5 cm, preferably greater than 0.6 cm and preferably greater than 0.7 cm, in at least one portion and in particular in an end portion and/or in a portion that contacts the plastics preforms.

In a further preferred embodiment, the first hold-down element performs a stroke that is smaller than 10 cm, preferably less than 8 cm, preferably less than 6 cm, preferably less than 5 cm, preferably less than 4 cm, preferably less than 3 cm and preferably less than 2 cm, in at least one portion, and in particular in an end portion and/or a portion that contacts the plastics preforms.

It has been shown that strokes in this region are highly suitable for safely eliminating any disruptions that occur.

In a further advantageous embodiment, the apparatus has a further transport unit for transporting the plastics preforms, wherein this transport unit preferably has a first transport roller that can rotate about a first axis of rotation and a second transport roller that can rotate about a second axis of rotation, and preferably a gap is formed between this first transport roller and the second transport roller, through which gap the base bodies of the plastics preforms, but not a support ring of the plastics preforms, pass or can pass.

Preferably, this is a so-called roller sorter, which is preferably placed upstream of the device described above. Preferably, the specified transport unit is therefore arranged in front of the above-mentioned transport elements.

The present invention further relates to an arrangement for treating plastics containers with an apparatus of the type described above. Furthermore, the arrangement has an apparatus for heating plastics preforms, which is preferably arranged downstream of the apparatus described above in the apparatus of the plastics preforms.

The present invention further relates to a method for transporting plastics preforms, wherein the plastics preforms are transported and/or conveyed along a first transport element that extends along a transport path of the plastics preforms and also along a second transport element that extends parallel to the first transport element, wherein the first transport element and the second transport element are spaced apart from one another such that a gap is formed between the first transport element and the second transport element such that a base body of the plastics preforms passes through this gap, but a support ring and/or a thread of the plastics preforms does not pass through this gap and/or is retained by the transport elements.

The apparatus also has a hold-down device, which is arranged above the transport elements and/or above the mouths of the plastics preforms and which at least temporarily contacts and/or guides the plastics preforms.

According to the invention, the hold-down device has a hold-down element that can move in two opposite directions in a longitudinal direction of the plastics preforms, along with a drive device that causes these movements during the transport operation of the apparatus.

It is therefore also proposed on the method side that a movable hold-down element and in particular a periodically movable hold-down element is provided, which serves to eliminate disruptions.

It is possible for this hold-down element to move continuously during operation of the apparatus and/or during transportation of the plastics preforms. However, it would also be possible for this movement to be triggered only if a disruption such as jamming of the plastics preforms is detected and/or identified.

Particularly preferably, the hold-down element is moved periodically. Preferably, the hold-down element moves in a circle.

Particularly preferably, the plastics preforms are transported in a straight line.

Particularly preferably, the hold-down element is moved with an eccentric drive or an eccentric drive mechanism.

In a further preferred embodiment, the plastics preforms are further transported or guided by a second hold-down element, wherein this second hold-down element preferably is arranged in a stationary manner with respect to the transport path of the plastics preforms.

### BRIEF DESCRIPTION OF THE DRAWINGS

Further advantages and embodiments can be seen in the accompanying drawings:

In the drawings:

FIG. 1 is a representation of an apparatus according to the invention; and

FIG. 2 is a representation of the apparatus with an upstream roller sorter.

### DETAILED DESCRIPTION OF THE INVENTION

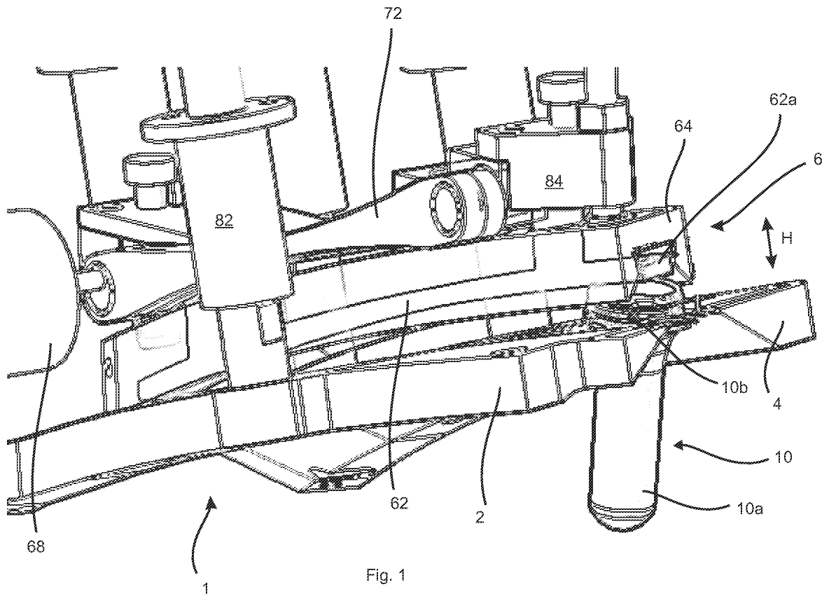

FIG. 1 is a representation of an apparatus according to the invention. A first transport element 2 in the form of a first transport rail and a second transport element 4 in the form of a second transport rail are provided. Plastics preforms 10 are transported between these two transport elements 2, 4. A base body 10a of the plastics preforms, but not the support ring 10b of the plastics preforms, can pass through the gap formed between the transport elements 2, 4.

The reference sign 6 in its entirety designates a hold-down device that guides the plastics preforms during their movement or during transportation.

The hold-down device 6 has a first hold-down element 62, which is designed to be movable. In addition, the hold-down device 6 has a second hold-down element 64, which is immovably or fixedly arranged. Preferably, both the first hold-down element 62 and the second hold-down element 64 form contact surfaces that are suitable and intended for contacting the plastics preforms or their mouths.

The first hold-down element is guided or arranged in a recess of the second hold-down element 64.

In a preferred embodiment, a contact surface of the first hold-down element runs parallel to a mouth surface of the plastics preforms, more precisely a mouth surface of the plastics preforms, if they are transported in a target position.

Preferably, a contact surface of the first hold-down element runs in a plane that is parallel to a support plane formed by the transport elements 2, 4, in which the plastics preforms are transported and/or in which their support rings are supported.

Preferably, one contact surface of the second hold-down element 64 is beveled. Particularly preferably, the second hold-down element has two contact surfaces between which the plastics preforms 10 are guided. Preferably, these contact surfaces run upwards towards one another in the longitudinal direction of the plastics preforms.

Preferably, at least one contact surface of the second hold-down element runs at an angle to a support plane formed by the transport elements 2, 4, in which support plane the plastics preforms are transported and/or in which their support rings are supported.

The reference sign 68 designates a drive device that causes a movement of the first hold-down element 62 in the direction H via a connecting rod 72. As mentioned above, this is a periodic movement that is initiated by the drive device 68, which is in particular an electric motor.

The reference sign 82 designates a carrier on which the transport element 2 is arranged. A height position of the transport element 2 can also be changed in this way.

A further carrier for holding the transport element 4 is located on the rear side of the device.

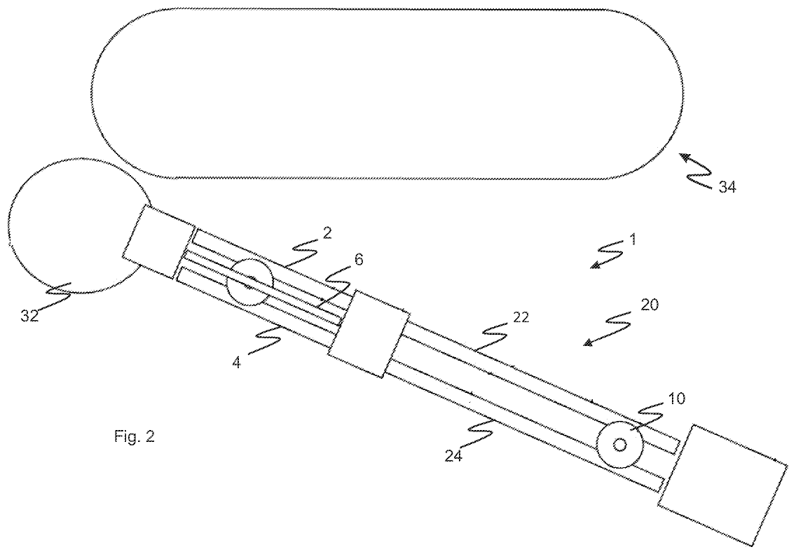

FIG. 2 is a further view of an apparatus 1 according to the invention. An optional transport unit 20 is also provided here, which is preferably placed in front.

Particularly preferably, this transport unit 20 has a first rotatable roller 22 and a second rotatable roller 24. The plastics preforms are transported between these rollers 22, 24, which preferably also causes alignment.

Preferably, the transport element 2 extends in the direction of the first rotatable roller. Preferably, the transport element 4 extends in the direction of the second rotatable roller.

In a further preferred embodiment, the distance between the first rotatable roller 22 and the second rotatable roller 24 is the same as the distance between the first transport element 2 and the second transport element 4.

The apparatus 1 preferably transfers the plastics preforms to a clocking-in device such as a clocking-in star, and this clocking-in star in turn preferably feeds the plastics preforms to a heating device for heating these plastics preforms.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for transporting plastics preforms, having a first transport element that extends along a transport path of the plastics preforms and having a second transport element that extends parallel to the first transport element, wherein the first transport element and the second transport element are spaced apart from one another such that a gap is formed between the first transport element and the second transport element such that a base body of the plastics preforms can pass through this gap, but a support ring of the plastics preforms cannot pass through this gap, wherein the apparatus furthermore has a hold-down device that is arranged above the transport elements and/or above the mouths of the plastics preforms,
wherein
the hold-down device has a first hold-down element movable in two opposite directions in a longitudinal direction of the plastics preforms along with a drive device that is configured to cause these movements during a transport operation of the apparatus.

2. The apparatus according to claim 1,
wherein
the drive device is configured to generate periodic movements of the first hold-down element and/or the drive device is configured to generate circular movements of the first hold-down element.

3. The apparatus according to claim 1,
wherein
the apparatus has a second hold-down element and the first hold-down element is movably arranged with respect to the second hold-down element.

4. The apparatus according to claim 3,
wherein
the second hold-down element is arranged in a stationary position.

5. The apparatus according to claim 3,
wherein
the second hold-down element has a recess and the first hold-down element is arranged in this recess.

6. The apparatus according to claim 1,
wherein
the first transport element and/or the second transport element is designed as a transport rail.

7. The apparatus according to claim 3,
wherein
the first hold-down element is configured to perform a stroke relative to the second hold-down element that is greater than 0.1 cm and/or the first hold-down element is configured to perform a stroke relative to the second hold-down element that is less than 10 cm.

8. The apparatus according to claim 1,
wherein
the apparatus has a transport unit for transporting the plastics preforms, wherein this transport unit has a first transport roller that is configured to rotate about a first axis of rotation and a second transport roller that is configured to rotate about a second axis of rotation.

9. An arrangement for treating plastics containers with an apparatus according to claim 1, and an apparatus for heating plastics preforms, which is arranged downstream of the apparatus in the transport direction of the plastics preforms.

10. A method for transporting plastics preforms, wherein the plastics preforms are conveyed along a first transport element, which extends along a transport path of the plastics preforms, along with along a second transport element, which extends parallel to the first transport element, wherein the first transport element and the second transport element are spaced apart from one another such that a gap is formed between the first transport element and the second transport element such that a base body of the plastics preforms passes through this gap, but a support ring of the plastics preforms does not pass through this gap, wherein the apparatus furthermore has a hold-down device that is arranged above the transport elements and/or above the mouths of the plastics preforms,
wherein
the hold-down device has a first hold-down element movable in two opposite directions in a longitudinal direction of the plastics preforms along with a drive device that causes these movements during a transport operation of the apparatus.
